(19) United States
(12) Patent Application Publication
(10) Pub. No.: US 2025/0014158 A1
(43) Pub. Date: Jan. 9, 2025

(54) EMPIRICAL CHARACTERIZATION OF USER EXPERIENCE WITH ARBITRARY WORKLOADS IN VDI ENVIRONMENTS

(71) Applicant: VMware, Inc., Palo Alto, CA (US)

(72) Inventors: Hari SIVARAMAN, Livermore, CA (US); Mohammad Zahangir HOSSAIN, Folsom, CA (US)

(21) Appl. No.: 18/348,184

(22) Filed: Jul. 6, 2023

(51) Int. Cl. G06T 7/00

(52) U.S. Cl. CPC G06T 7/0002; G06T 2207/20048; G06T 2207/20084; G06T 2207/30168

(57) ABSTRACT

The disclosure provides an approach for verifying and improving the visual experience on client machines located on a virtual desktop infrastructure (VDI) system in response to measuring various metrics of the visual display. The metrics include frame rate, smoothness, and image quality. The metrics are obtained by using an arbitrary workload. Obtaining the metrics involves running screenshots of the arbitrary workload through convolutional neural nets to measure blemishes and blurriness.

### BACKGROUND

Visual user experience (i.e., display quality) in virtual desktop infrastructure (VDI) is defined primarily by frames per second (FPS), smoothness, and the quality of the images that are delivered to the end user. An important step to guaranteeing a high quality user experience is to measure metrics around the FPS, smoothness, and quality of the images that are delivered to the end user by a VDI installation.

In a VDI environment, screen content is generated based on input keystrokes or mouse events issued by the user, rather than by a remote video. The screen content is unique and highly individualized. The content delivered to the user is mostly unique to that user and is defined by their actions at an earlier point in time. Many techniques used to measure user experience in VDI either assume a particular underlying distribution of pixel intensities or are based on measuring visual user experience of other use cases such as video streaming technology. In these techniques, users are often asked to run “canned” and one-size-fits-all workloads. However, the canned workloads can differ from how the end users of VDI use their computers. Measurements of user experience using these canned workloads end up not matching the reality of how the users of VDI use their computers. Instead of canned workloads, arbitrary workloads have the potential to provide more accurate measurement results, and thereby, to improve visual user experience (i.e., visual display quality).

### SUMMARY

Embodiments provide a method of verifying a quality of virtual desktop infrastructure (VDI) display, the method comprising: (a) selecting n-th and (n+1)-th sequential screenshots of a set of N screenshots taken on a client device of a VDI system; (b) performing structural similarity index measure (SSIM) on the two sequential screenshots to determine whether the two sequential screenshots are distinct; (c) determining whether the n-th screenshot is a blurry version of the (n+1)-th screenshot; (d) in response to determining that the n-th screenshot is not a blurry version of the (n+1)-th screenshot, incrementing a frames per second (FPS) counter; (e) incrementing n and repeating steps (a)-(e) until all of the screenshots have been selected; and (f) verifying the quality of the VDI based on a value of the FPS counter.

Further embodiments include a non-transitory computer-readable storage medium storing instructions that, when executed by a computer system, cause the computer system to perform the method set forth above, and a computer system programmed to carry out the method set forth above.

### BRIEF DESCRIPTION OF THE DRAWINGS

FIG. 1 depicts components of a VDI system in which one or more embodiments of the present invention may be implemented.

FIG. 2 depicts a block diagram of a host, according to an embodiment.

FIG. 3 depicts a block diagram of blur CNN, according to an embodiment.

FIG. 4 depicts a block diagram of blemish CNN, according to an embodiment.

FIG. 5 depicts a block diagram of dual blur CNN, according to an embodiment.

FIG. 6 depicts a flow diagram of a method of improving VDI display quality in response to measuring the VDI display quality, according to an embodiment.

FIG. 7 depicts a flow diagram of a method of measuring frames per second of VDI screenshots, according to an embodiment.

FIG. 8 depicts a flow diagram of a method of measuring smoothness of VDI screenshots, according to an embodiment.

FIG. 9 depicts a flow diagram of a method of measuring image quality of VDI screenshots, according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

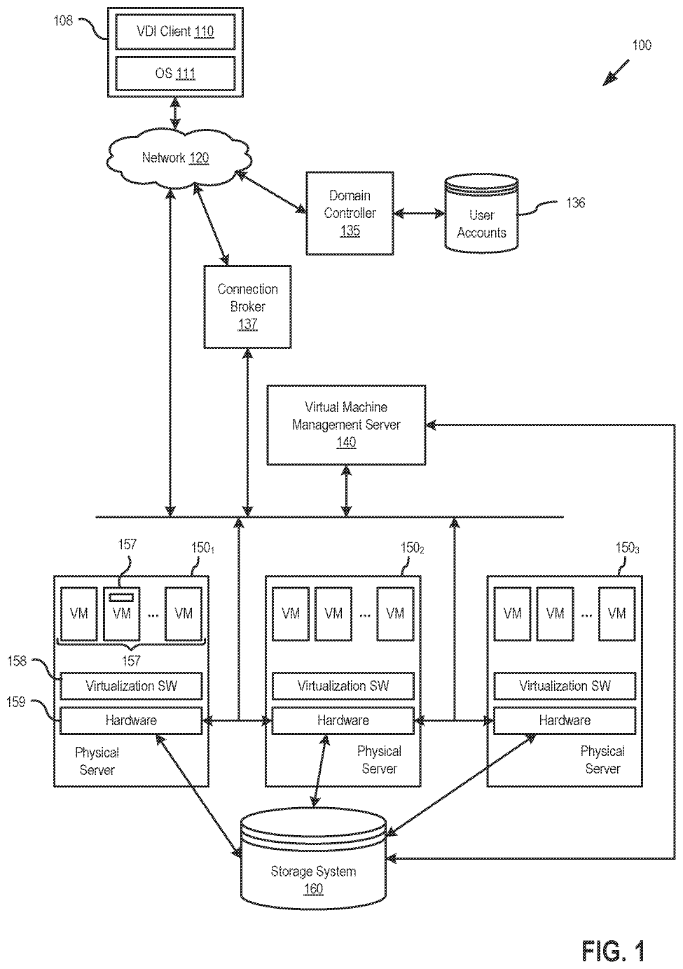

The disclosure provides an approach for improving visual user experience delivered by VDI to client devices in response to measuring the experience via arbitrary workloads. FIG. 1 depicts components of a virtualized desktop infrastructure (VDI) system 100 in which one or more embodiments of the present invention may be implemented. In VDI system 100, VDI client software programs (also referred to as “VDI clients” for short), e.g., VDI client 110, run on operating systems of local computing devices, e.g., client machine 108 on top of an operating system (OS) 111. VDI clients provides an interface for the users to access their desktops, which may be running in one of virtual machines or virtual computing instances 157 or blade server (not shown) in a data center that is remote from the user locations. The term, “desktop” refers to the instance of an interactive operating environment provided by a computer operating system and software applications, typically in the form of a display and sound output and keyboard and mouse input. With VDI clients, users can access desktops running in a remote data center through network 120, from any location, using a general purpose computer running a commodity operating system and a VDI client software program such as VMware® View™, or a special purpose thin client such as those available from Dell, HP, NEC, Sun Microsystems, Wyse, and others.

VDI system 100 includes a domain controller 135, such as Microsoft® Active Directory®, that manages user accounts 136 including user log-in information, and a connection broker 137 that manages connections between VDI clients and desktops running in virtual machines 157 or other platforms. Domain controller 135 and connection broker 137 may run on separate servers or in separate virtual machines running on the same server or different servers. In the embodiments of the present invention illustrated herein, desktops are running in virtual machines 157 and virtual machines 157 are instantiated on a plurality of physical computers 1501-3, each of which includes virtualization software 158 and hardware 159, is controlled by a virtual machine management server 140, and is coupled to a shared persistent storage system 160.

All of the components of VDI system 100 communicate via network 120. For simplicity, a single network is shown but it should be recognized that, in actual implementations, the components of VDI system 100 may be connected over the same network or different networks. Furthermore, a particular configuration of the virtualized desktop infrastructure is described above and illustrated in FIG. 1, but it should be recognized that one or more embodiments of the present invention may be practiced with other configurations of the virtualized desktop infrastructure.

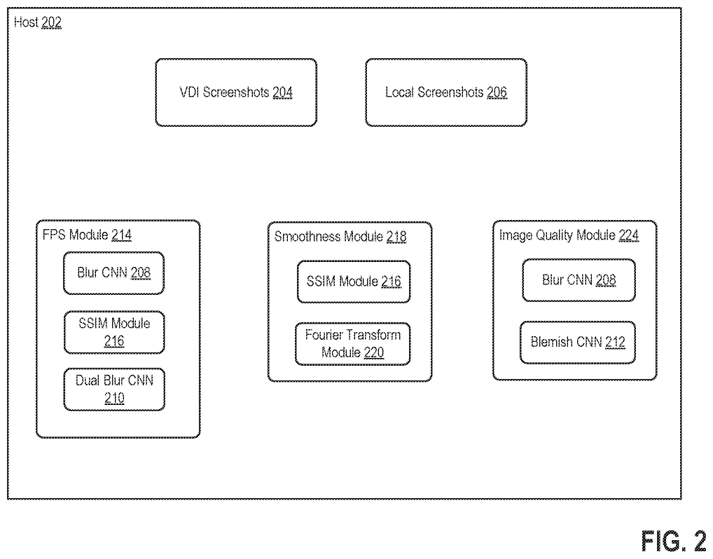

FIG. 2 depicts a block diagram of a host 202, according to an embodiment. Host 202 may be any machine with a processor, such as a laptop or a desktop computer. Host 202 comprises various software and data used to take measurements of visual user experience on client machine 108. Host 202 comprises VDI screenshots 204, local screenshots 206, FPS module 214, smoothness module 218, and image quality module 224. Although components of host 202 are shown as located within host 202, the components may be located anywhere that is accessible by host 202.

VDI screenshots 204 are a series of screenshots and can be thought of as a video. VDI screenshots 204 are shots of the screen of client machine 108, or shots of what would be on the screen of client machine 108 if client machine 108 does not have a screen. VDI screenshots 204 are taken while running a workload (not shown) on client machine 108. Ideally, the screenshots are taken at a frame rate that is equal to or greater than the frame rate at which VDI system 100 runs or is intended to run. For example, if VDI system 100 runs at 24 frames per second (FPS), then the screenshots at client machine 108 should be taken at 24 or more FPS. As explained above with respect to FIG. 1, actions taken on client machine 108 are sent to one of VMs 157, which then processes the action and sends the resulting screen back to client machine 108, and this process might result in some loss of quality of the screen image.

A workload may be performed by a script or by manually performing actions. The workload is arbitrary, and ideally reflects the type of actions performed by a human user of client machine 108. For example, a workload may involve opening one or more software programs commonly used by a user, optionally manipulating a file, saving that file, etc.

Local screenshots 206 are a series of screenshots and can be thought of as a video. Local screenshots 206 are shots of the screen (or shots of what would be on the screen if a screen is not connected) of a locally ran machine, such as host 202, where actions are processed on a processor located locally to that machine. This is in contrast to actions that are processed remotely as in VDI system 100. Local screenshots 206 represent an “ideal” visual user experience, because there is minimization of interference and other image altering processing (e.g., data compression) between use action and visual result of that action on a screen. Local screenshots 206 are taken while running the same workload used to create VDI screenshots 204. The frame rate of local screenshots 206 is the same as the frame rate of VDI screenshots 204.

The techniques described herein focus on measuring three aspects of visual VDI user experience. The three aspects are FPS, smoothness, and image quality, which are each discussed below.

FPS module 214 measures frames per second, or FPS. FPS module 214 comprises blur CNN 208, SSIM module 216, and dual blur CNN 210. FPS is the number of distinct frames displayed per second at the client side, i.e., on client machine 108. Typically, VDI sessions operate at about 24 FPS, however, this number can vary depending on user actions. FPS is a fundamental measure of user experience. Low values of FPS might indicate poor user experience. The techniques herein use a no reference approach to measuring FPS. This means that local screenshots 206 are not used to measure FPS. Instead, FPS module 214 uses VDI screenshots 204 to measure FPS without reference or comparison to the “ideal” local screenshots 206. The techniques herein did not use watermarks on the screen of client machine 108 when creating VDI screenshots 204, and therefore VDI screenshots 204 do not have watermarks, and watermarks are not used for FPS measurements. Instead, FPS module 214 herein identifies the number of screenshots with distinct content.

The traditional or popular approach to measure FPS is to compute the SSIM (structural similarity metric) of every pair of screenshots in the recorded sequence. If the SSIM value turns out less than an arbitrary threshold, the first screenshot of the pair is counted as a unique frame, otherwise it is discarded as a duplicate. The drawback to this approach stems from how VDI protocols and most modern lossy compression schemes function, which is by using build to lossless, or sharpening mechanisms, whereby VDI protocols first display a blurred image which is then sharpened up. This leads to overcounting because blurred frames that are subsequently sharpened up are all counted as distinct frames.

SSIM module 216 runs a standard SSIM process on two successive screenshots. Blur CNN 214 is a neural net, described below, that makes a final determination as to whether two successive screenshots are blurred versions of each other.

To measure frames per second, FPS module 214 compares successive screenshots, two at a time. If the two screenshots are identical or one is a blurred version of the other, then the first screenshot is discarded as a duplicate. FPS module 214 begins by running SSIM module 216 with the two successive screenshots as input to identify potential distinct frames. As is known in the art, SSIM is a technique that compares two images and returns a similarity score. The similarity score can vary between a range, such as for example a range between 0 and 1, with 1 denoting identical images, or for another example a range between −1 and 1, with 1 denoting identical images. The cutoff SSIM value for “distinct” and “not distinct” can vary and can be set by a developer as per general standards or per preference. If SSIM module 216 determines that the two screenshots are candidates for being counted as distinct frames, then FPS module 214 runs the first of the two screenshots through blur CNN 208.

If the “earlier in time” screenshot of a screenshot pair is blurry, it may or may not be a blurry version of the second or later screenshot of the pair. To determine if it is, the two screenshots are run through dual blur CNN 210. If the first screenshot is a blurred version of the second, then FPS module 214 does not count the first screenshot, avoiding overcounting.

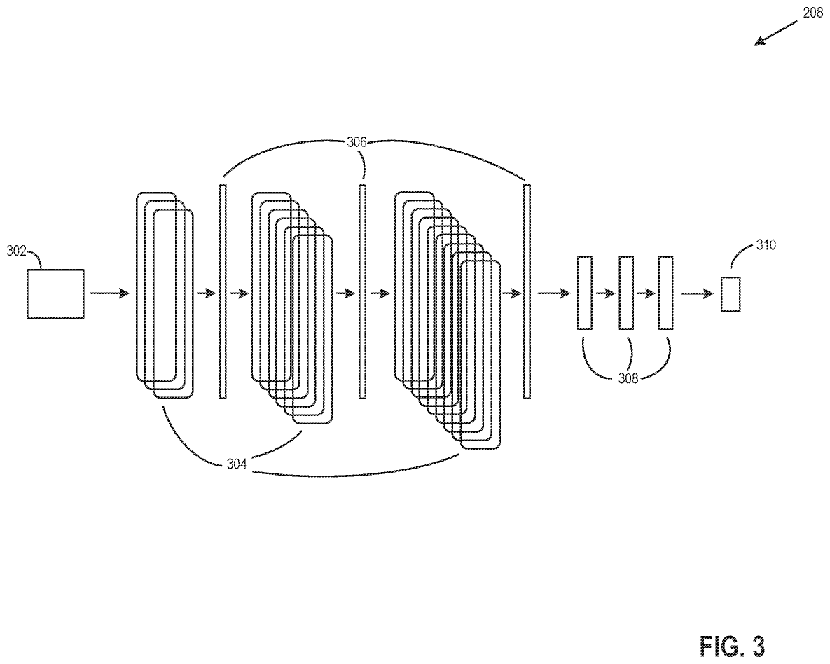

FIG. 3 depicts a block diagram of blur CNN 208, according to an embodiment. Blur CNN 208 is a convolutional neural net that detects whether a screenshot 302 is blurred or not. As its input, blur CNN 208 takes VDI screenshots 204, one screenshot at a time. Screenshot 302 is a single sequential screenshot taken from VDI screenshots 204.

Blur CNN 208 has nine layers. The first, third, and fifth layers are convolution layers 304 that filter data of screenshot 304. Convolution layers 304 are 3×3 filter layers with a stride of 1. A convolution layer is a fundamental building block of CNNs, responsible for performing the convolution operation on input data, which is sequential screenshots 302 from VDI screenshots 204. The primary purpose of a convolution layer is to learn and extract local features from screenshot 302 by applying filters (also known as kernels) to screenshot 302. A filter is a small matrix of weights that slides over the input data in a sliding-window fashion. At each position of the filter, element-wise multiplication is performed between the filter's weights and the corresponding input values, followed by summing the results to generate a single value. This process is repeated for the entire screenshot 302, resulting in a new feature map that highlights certain features or patterns.

A 3×3 filter is a small matrix (3 rows and 3 columns) of weights that slide over the input image, screenshot 302. As the filter moves, it performs element-wise multiplication between its weights and the corresponding pixels in the image, then sums the results to produce a single value. This process generates a new feature map that highlights certain features in the input screenshot 302.

Convolution layers 304 have a stride of 1. Stride is the number of pixels that a filter shifts over the input data (screenshot 302). When the stride is 1, filters move 1 pixel at a time. Stride is a hyperparameter that controls how the filter slides over screenshot 302, and it affects the size of the resulting output feature map.

The second, fourth, and sixth layers are 2×2 max pool layers 306. A max pool layer is a type of layer that performs downsampling on the input data, such as feature maps, in order to reduce their spatial dimensions. The primary purposes of max pooling layers 306 are to reduce computational complexity, control overfitting, and improve translation invariance in the network. Max pooling layers 306 operate by sliding a window (or pooling window) of a size 2×2 over screenshot 302 in a non-overlapping manner. For each region covered by the pooling window, the maximum value is selected and used to create a new, smaller feature map. Together, convolution layers 304 and max pool layers 306 are six filter layers.

Once blur CNN 208 finishes filtering screenshot 302 through the six filter layers, then three fully connected layers 308 process features that emerge from the filter layers to generate a non-linear function of the features. Fully connected layers 308 (also known as dense layers or linear layers) are used to perform high-level reasoning and produce final output predictions after the feature extraction process. Fully connected layers 308 connect every neuron in one layer to every neuron in the next layer, forming a dense interconnection of weights and biases. In blur CNN 208, convolution layers 304 and pooling layers 306 are responsible for extracting relevant features from screenshot 302, and after the feature extraction process, the data is flattened or reshaped into a one-dimensional vector, which is then fed into three fully connected layers 308. Three functions of fully connected layers 308 are as follows. (1) Fully connected layers 308 learn to combine and interpret the features extracted by the convolution layers 304 and pooling layers 306 to make final or near final predictions. (2) The last fully connected layer typically has a number of output neurons corresponding to the number of classes in a classification task or the desired output size in a regression task. An appropriate activation function, such as sigmoid activation function 310, is applied to produce the final output predictions. (3) The weights and biases in fully connected layers 308 are learned during the training process along with the weights of the convolution layers 304, allowing for end-to-end learning of the entire network.

After the three fully connected layers 308, the processed result goes through sigmoid activation function 310, which performs binary classification to decide whether screenshot 302 is blurred or not. Sigmoid activation function 310 may represented, for example, by formula σ(x)=1/(1+e\hat{ }(−x)), which maps input values to a range between 0 and 1. The output can be interpreted as the probability of the input belonging to a certain class, such as whether screenshot 302 is blurry or not. For instance, an output value closer to 1 would indicate a higher probability of screenshot being blurry, while a value closer to 0 would suggest a higher probability of screenshot 302 being not blurry.

The values of the six filter layers are not given by a programmer, but learned from training data. In an embodiment, blur CNN 208 is trained using a supervised learning technique. A set of images, each of which has been correctly labelled as “blurred” or “not-blurred” by a human, may be used as input. Blur CNN 208 learns from this labelled dataset. To create the dataset, one may collect screenshots while running on a local laptop one or more of the following software: web browser, a portable document format (PDF) reader, word processing software, an email client, a file manager, and/or a group messaging software. Screenshots were collected while operating these applications similarly to a typical working day. The screenshots are unblurred images, and become labelled as not-blurred. Afterwards, to each one of these screenshots, classical blurring techniques may be applied, like “mean-filter” with three different filter sizes, “median filter” with three different filter sizes, a Gaussian filter, and/or JPEG filtering using different JPEG quality levels. The blurred image output from these filters were labelled as blurred. This process allows for creation of a dataset of over a million images, each of which is labeled blurred or not-blurred, and blur CNN 208 is trained using this dataset.

A detailed description, as per an embodiment, of blur CNN 208 in pyTorch syntax is shown below. PyTorch is an opensource machine learning framework based on the opensource library, Torch.

```
class blurModel(nn.Module):
  def __init__(self):
    super( ).__init__( )
    self.C0=nn.Conv2d(in_channels-3, out_channels=6, kernel_size=3, stride=1)
    self.C1=nn.Conv2d(in_channels=6, out_channels=9, kernel_size=3, stride=1)
    self.C2=nn.Conv2d(in_channels=9, out_channels=12, kernel_size=3, stride=1)
    self.fc0=nn.Linear(in_features=12*30*30, out_features=4*30*3)
    self.fc1=nn.Linear(in_features-4*30*3, out_features-4*3*3)
    self.fc2=nn.Linear(in_features=4*3*3, out_features=2)
  def forward(self, X):
    X=F.max_pool2d( F.relu(self.C0(X)), 2, 2)
    X=F.max_pool2d( F.relu(self.C1(X)), 2, 2)
    X=F.max_pool2d( F.relu(self.C2(X)), 2, 2)
    X=X.view(-1, 12*30*30)
    X=F.relu(self.fc0(X))
    X=F.relu(self.fc1(X))
    X=F.log_softmax( self.fc2(X), dim=1)
    return X
```

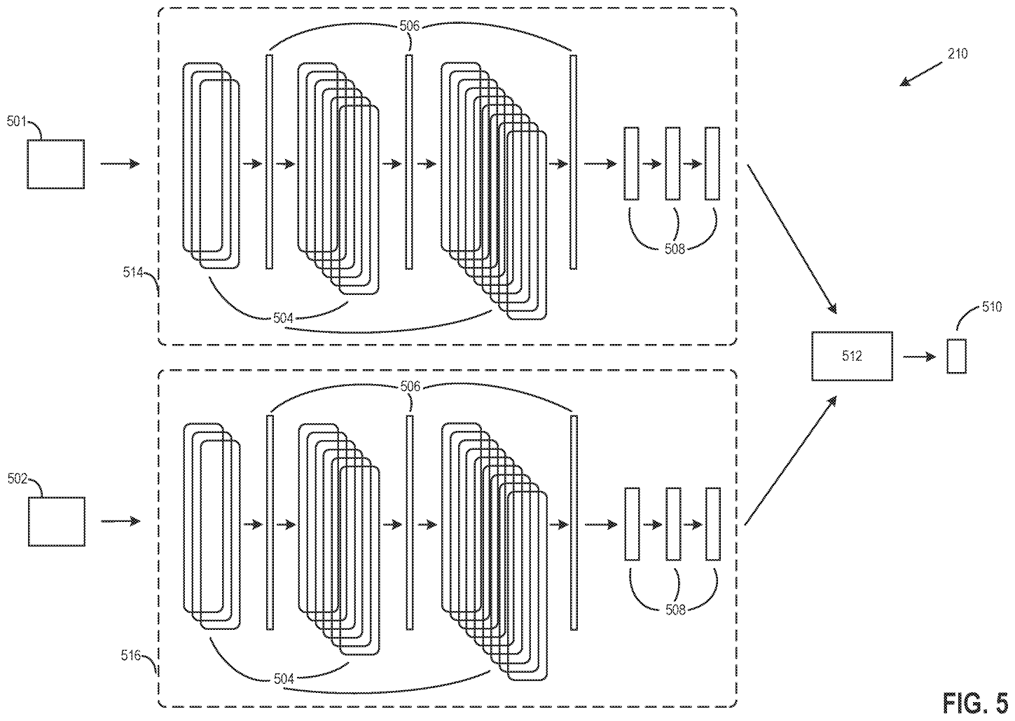

FIG. 5 depicts a block diagram of dual blur CNN 210, according to an embodiment. Dual blur CNN 210 is a convolutional neural net used to detect if VDI screenshot 501 is a blurred version of local screenshot 502. In an embodiment, dual blur CNN 210 takes as input two sequential screenshots from the same sequence of screenshots (e.g., VDI screenshots 204) to determine whether one is a blurred version of the other. In an embodiment, dual blur CNN 210 does not compare screenshots from two separate sequences, such as VDI screenshots 204 and local screenshots 206, due to the difficulty of aligning screenshots from different sequences.

Dual blur CNN 210 has two component CNNs-top model 514 and bottom model 516-whose output is compared. Dual blur CNN 210 takes two screenshots 501/502 as input. One screenshot 501 goes through top model 514, the second screenshot 502 goes through bottom model 516, and their outputs are compared to generate a true or false result indicating whether one screenshot is a blurred version of the other or not. In an embodiment, top model 514 and bottom model 516 are identical. Each component model 514/516 has a total of eleven layers with eight layers in front being convolution layers 504 interspersed with max pool layers 506. Convolution layers 504 and max pool layers 506 implement the equivalent of classical filtering operations in image processing. A difference is that the values of the filters are not given by the programmer but learned from the data. Once the filtering is done, the three fully connected layers 508 (linear layers) generate a non-linear function of the features that emerge from convolution layers 508. Outputs of the two models 514/516 are compared to calculate an absolute difference 512, which is fed into the sigmoid activation function 510 to generate a zero or one output. Output of sigmoid activation function 310 indicates whether one screenshot is a blurred version of the other.

In an embodiment, dual blur CNN 210 is trained using a supervised learning technique. The data used may be drawn from the dataset generated to train the model for blur CNN 208. For training, dual blur CNN 210 takes two images as input and classifies them as a “blurred pair” or “not a blurred pair.” In order to generate such a set, the following process may be followed. (1) Each un-blurred image in the dataset for blur CNN 208 has many blurred images generated from it. From this set, pairs of images are generated where the pair consists of <Original Image, Blurred version of that original> and the pair is labelled as a “blurred pair.” (2) Given an original image, I, pair the image with the blurred version of another image, J, that is distinct from the image I. The pair of images would be <I, blurred version of J>. Such a pair was labelled “not a blurred pair.” (3) From the set of unblurred images of the dataset of blur CNN 208, image pairs are generated such as <un-blurred images, un-blurred image distinct from the first> and the pair was labelled as “not a blurred pair.” This approach generated a large number of labelled data items which was used to train dual blur CNN 210.

A detailed description of dual blur CNN 210 in pyTorch syntax is shown below, according to an embodiment.

```
class fpsModel(nn.Module):
  def __init__(self):
    super( ).__init__( )
    self.C0=nn.Conv2d(in_channels=3, out_channels=6, kernel_size=3, stride=1)
    self.C1=nn.Conv2d(in_channels=6, out_channels=9, kernel_size=3, stride=1)
    self.C2=nn.Conv2d(in_channels=9, out_channels=16, kernel_size=3, stride=1)
    self.C3=nn.Conv2d(in_channels=16, out_channels=24, kernel_size=3, stride=1)
    self.fc0-nn.Linear(in_features-24*14*14, out_features=20*14*14)
    self.fc1=nn.Linear(in_features-20*14*14, out_features=16*14*14)
    self.fc2=nn.Linear(in_features=16*14*14, out_features=12*14*14)
    self.fcFinal=nn.Linear(in_features=12*14*14, out_features=2)
  def forward0(self, X):
    X=F.max_pool2d( F.relu(self.C0(X)), 2, 2)
    X=F.max_pool2d( F.relu(self.C1(X)), 2, 2)
    X=F.max_pool2d( F.relu(self.C2(X)), 2, 2)
    X=F.max_pool2d( F.relu(self.C3(X)), 2, 2)
    X=X.view(-1, 24*14*14)
    X=F.relu(self.fc0(X))
    X=F.relu(self.fc1(X))
    X=F.relu(self.fc2(X))
    return X
  def forward(self, X0, X1):
    X0=self.forward0(X0)
    X1=self.forward0(X1)
    D00=torch.abs(X0-X1)
    X=F.log_softmax(self.fcFinal(D00), dim=1)
    return X
```

After image quality module 224 obtains a ratio of unblemished screenshots to total screenshots, and a ratio of unblurred screenshots to total screenshots, optionally, image quality module 224 takes the mean of the two ratios, and uses that as the single final image quality metric. The mean may be an arithmetic or geometric mean.

Returning to FIG. 2, smoothness module 218 measures visual smoothness at VDI client machine 108. Smoothness, generally, is a measure of how gradually the display changes as the user triggers the change. Smoothness for arbitrary workloads only makes sense when measured in comparison to a reference. The reference can be the smoothness of the same workload on a local system. Because a particular workload might include jerky transformations in the screen content, an arbitrary measure of smoothness can mistakenly label a VDI session as not smooth when the workload itself is the cause of the jerkiness in the displayed images.

Smoothness module 218 comprises SSIM module 216 and Fourier transform module 220. SSIM module 216 of smoothness module 218 may be the same or similar module as SSIM module 216 of FPS module 214. SSIM module 216 may be shared between modules 214/218, or separate copies of SSIM module 216 may exist distinctly for modules 214/218. SSIM module 216 uses VDI screenshots 204 to compute a sequence of SSIM values by considering the sequential screenshots 204 pairwise. As discussed above, SSIM is a technique that compares two images and returns a similarity score, such as for example, a score between 0 and 1. The sequence of SSIM values produced by SSIM module 216 while processing VDI screenshots 204 is a time series. Fourier transform module 220 uses this time series to compute a Fourier transform frequency graph (i.e., spectrum) of the time series. Then, Fourier transform module 220 calculates the energy in the lower ⅔ of frequency of the graph, and this energy can be called “VDI energy.” In an embodiment, energy is calculated by calculating the area under the squared magnitude of the Fourier transform graph.

The value of VDI energy has little meaning on its own, without reference to the energy of local screenshots 206. This is because VDI screenshots 204 may be from a workload with jumpy, not smooth, image changes. The only way the value of VDI energy can be used is if compared to energy of a timeseries from a reference system, such as a local laptop running the same workload. If a time series has many sharp jumps, then the time series will have more high frequency components and hence less energy in the lower ⅔ of the spectrum (i.e., the Fourier transform graph). That is, the lower the energy in the lower ⅔ of the Fourier transform graph, the lower the smoothness (higher jerkiness) of the screenshots used to compute the time series. Comparing the low frequency energy for VDI screenshots 204 with that for local screenshots 206 (the reference system) indicates how smooth is the visual experience of client machine 108 of VDI system 100. To obtain the reference energy, smoothness module 218 performs the same steps it did for VDI screenshots 204 but for local screenshots 206.

SSIM module 216 uses local screenshots 206 to compute a sequence of SSIM values by considering the sequential screenshots 206 pairwise. The sequence of SSIM values produced by SSIM module 216 while processing local screenshots 206 is a time series. Fourier transform module 220 uses this time series to compute a Fourier transform frequency graph (i.e., spectrum) of the time series. Then, Fourier transform module 220 calculates the energy in the lower ⅔ of the graph, and this energy can be called “reference energy.”

Smoothness module 218 compares VDI energy with reference energy to determine smoothness on client machine 108. In an embodiment, the comparison is performed by dividing reference energy by VDI energy. In this embodiment, smoothness is a number between 0.0 and 1.0, where 1.0 is a perfect smoothness score.

At first impression, the above approach to measuring smoothness might seem like a “full reference” mechanism, but it is not for two reasons. First, the reference frames for a client VDI session are not captured from the corresponding desktop in the data center, but from any reference laptop running the same workload, and can be reused or shared by multiple VDI client sessions. Second, the purpose of using frames from a reference system is to account for workload characteristics, not to do a one-to-one comparison of frames, which is the hallmark of a full reference mechanism.

Image quality module 224 measures visual image quality on client machine 108. High image quality is the lack of blemishes and/or blurring on the screen of client machine 108. Blemishes are salt and pepper noise, splotches, black artifacts, or pincushion distortions on an image. Techniques herein determine image quality by counting the number of VDI screenshots 204 without blemishes and without blurring (the “good” images), and dividing by the number of total images. Image quality is the ratio of good images to total images. Image quality module 224 comprises blemish CNN 212 and blur CNN 208. Blur CNN 208 of image quality module 224 may be the same or similar as blur CNN 208 of FPS module 214. Blur CNN 208 may be shared between modules 214/224, or separate copies of blur CNN 208 may exist distinctly for modules 214/218.

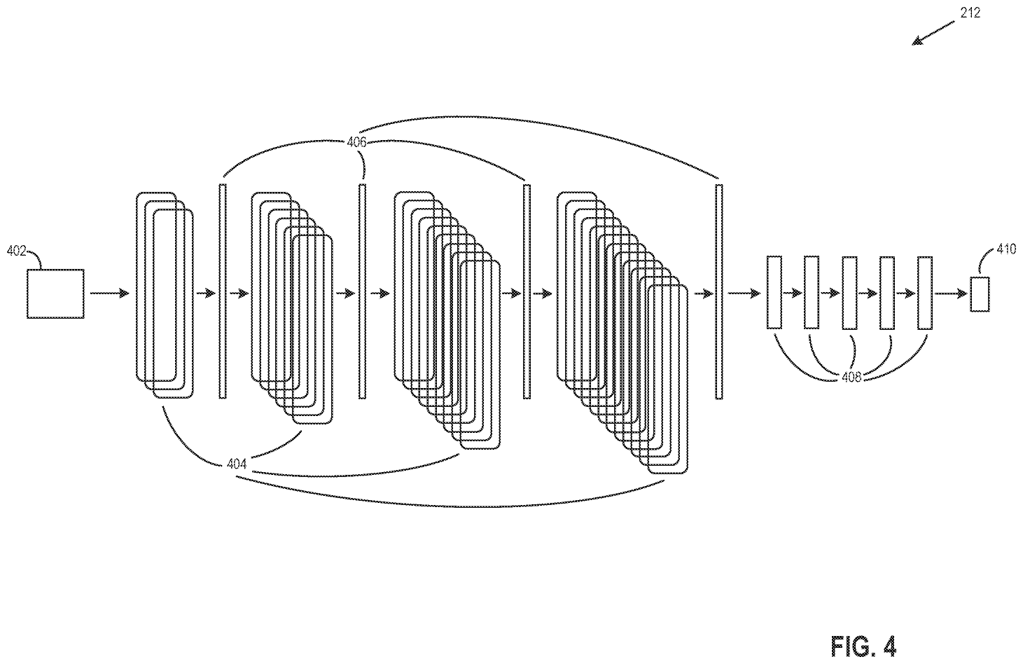

FIG. 4 depicts a block diagram of blemish CNN 212, according to an embodiment. Blemish CNN 212 is a convolutional neural net that takes as input one screenshot 402 at a time of VDI screenshots 204, sequentially, and determines whether screenshot 402 has blemishes. Blemish CNN 212 has thirteen layers, with the eight layers in front that consist of convolution layers 404 interspersed with max pool layers 406. Convolution layers 404 have a 3×3 filter with a stride of 1. Max pool layers 406 are 2×2 max pool layers.

Convolution layers 404, interspersed with max pool layers 406, implement the equivalent of classical filtering operations in image processing. A difference is that the values of the filters are not given by the programmer but learned from the data. Once the filtering is done, five fully connected layers 408 (linear layers) generate a non-linear function of features that emerge from convolution layers 404. After fully connected layers 408, the processed result goes through sigmoid activation function 410, which performs binary classification to decide whether screenshot 402 has blemishes or not.

In an embodiment, blemish CNN 212 is trained using a supervised learning technique. A set of images may be used, each of which has been correctly labelled as “blemished” or “not-blemished” by a human. Blemish CNN 212 model learns from this labelled dataset. To create the dataset, one may collect screenshots while running on a local laptop one or more of the following software: web browser, a portable document format (PDF) reader, word processing software, an email client, a file manager, and/or a group messaging software. Screenshots may be collected while operating these applications similarly to a typical working day. These screenshots are un-blemished images. From each unblemished image, a blemished image may be generated by doing one or more of the following operations:
Add salt-and-pepper noise.
Add splotches, and blocky regions of different sizes and colors.
Add splotches with halo effects.
Add pin-cushion distortion.

These effects were applied singly and in pairs to generate images with blemishes. The generated images are labeled blemished images. This process resulted in a labeled dataset with blemished and un-blemished images to train the blemish CNN 212 model.

A detailed description of blemish CNN 212 in pyTorch syntax is shown below, according to an embodiment.

```
class blemishModel(nn.Module):
  def __init__(self):
    super( ).__init__( )
    self.C0=nn.Conv2d(in_channels=3, out_channels=6, kernel_size=3, stride=1)
    self.C1=nn.Conv2d(in_channels=6, out_channels=8, kernel_size=3, stride=1)
    self.C2=nn.Conv2d(in_channels=8, out_channels=12, kernel_size=3, stride=1)
    self.C3=nn.Conv2d(in_channels=12, out_channels=16, kernel_size=3, stride=1)
    self.fc0=nn.Linear(in_features=16*14*14, out_features=12*14*4)
    self.fc1=nn.Linear(in_features=12*14*4, out_features-9*7*2)
    self.fc2=nn.Linear(in_features-9*7*2, out_features-6*3*2)
    self.fc3=nn.Linear(in_features-6*3*2, out_features=4*2*1)
    self.fc4=nn.Linear(in_features=4*2*1, out_features=2)
  def forward(self, X):
    X=F.max_pool2d( F.relu(self.C0(X)), 2, 2)
    X=F.max_pool2d( F.relu(self.C1(X)), 2, 2)
    X=F.max_pool2d( F.relu(self.C2(X)), 2, 2)
    X=F.max_pool2d( F.relu(self.C3(X)), 2, 2)
    X=X.view(-1, 16*14*14)
    X=F.relu(self.fc0(X))
    X=F.relu(self.fc1(X))
    X=F.relu(self.fc2(X))
    X=F.relu(self.fc3(X))
    X=F.log_softmax( self.fc4(X), dim=1)
    return X
```

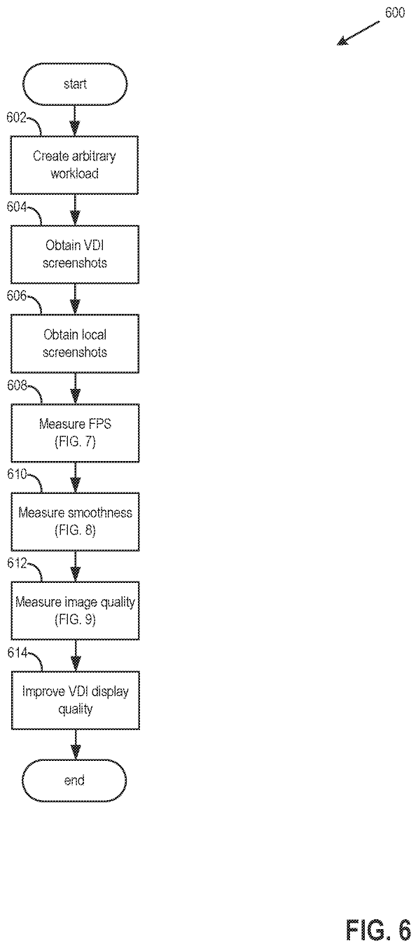

FIG. 6 depicts a flow diagram of a method 600 of improving VDI display quality in response to measuring the VDI display quality, according to an embodiment. Method 600 is also a method of verifying quality of VDI display, according to an embodiment.

At block 602, an arbitrary workload is created, such as by recording a sequence of actions, such as through a script. The workload may be created by a system administrator or a software program.

At block 604, the workload created at block 602 is executed on client machine 108 using VDI system 100, and VDI screenshots 204 are recorded at client machine 108.

At block 606, screenshots are recorded locally by having the workload created at block 602 executed locally on a computer, such as host 202 without using VDI system 100 or a similar system, and local screenshots 206 are recorded on or by host 202. As used herein, screenshots “recorded locally” means that the machine/processor executing the workload and the machine/processor recording the resulting screenshots are located locally. As used herein, “local” or “locally” means on the same machine or on the same local area network (LAN).

Because some of blocks 608, 610, 612 do not use local screenshots 206, and because some of blocks 608, 610, 612 may be skipped during method 600, in an embodiment, block 606 may also be skipped.

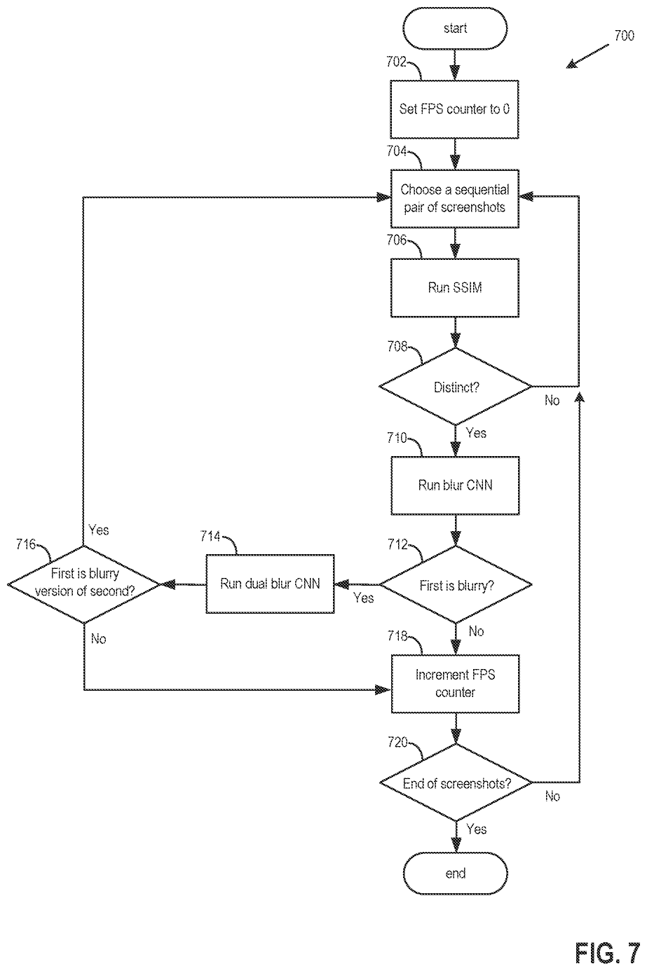

At block 608. FPS of VDI screenshots 204 is measured. Block 608 is further expanded upon in FIG. 7.

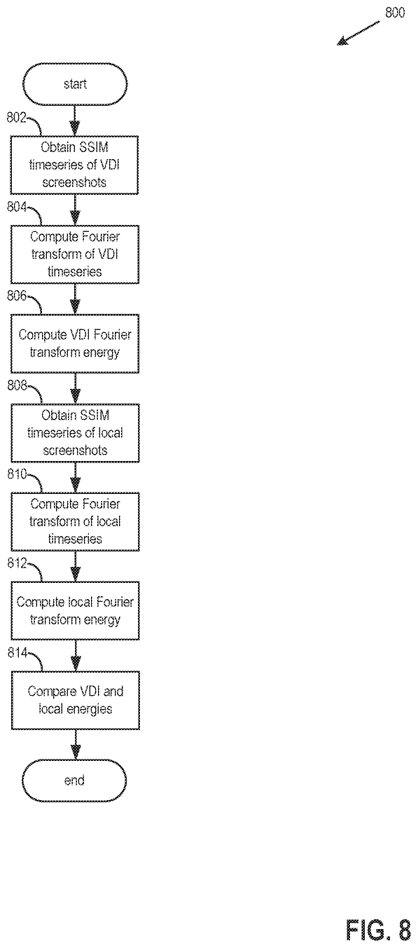

At block 610, smoothness of VDI screenshots 204 is measured. Block 610 is further expanded upon in FIG. 8.

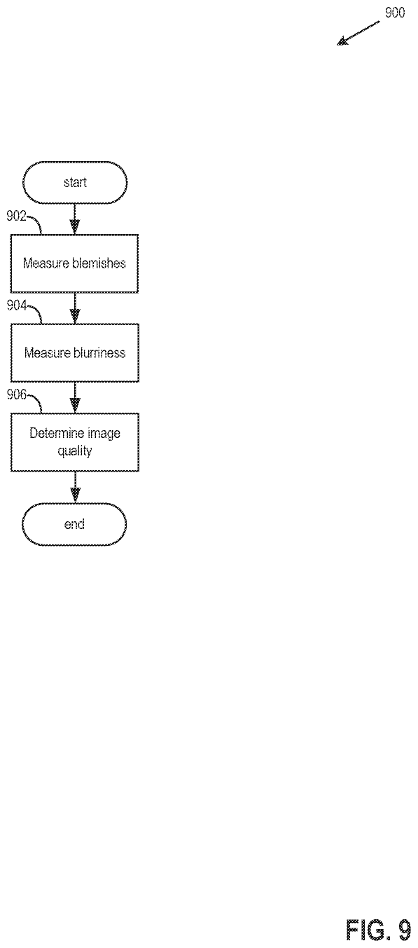

At block 612, image quality (blurriness and blemishes) of VDI screenshots 204 is measured. Block 612 is further expanded upon in FIG. 9.

At block 614, the measurements from some or all of blocks 608, 610, 612 are used to improve VDI display quality at client machine 108 of VDI system 100. Display quality may be improved by upgrading dedicated hardware encode/decode engine of physical computers 150 of the data center of VDI system 100. Display quality may be improved by upgrading the graphics processing unit (GPU) of physical computers 150 of VDI system 100. Display quality may be improved by upgrading embedded GPU of client machine 108. As used herein, the term “upgrade” or “upgrading” a component also includes adding that component, if the component is not present in the machine or system being upgraded. After block 614, method 600 ends.

In an embodiment, not all of blocks 608, 610, and 612 need to be performed for method 600 to continue to block 614 and improve VDI display quality of client machine 108. Rather, one or two of blocks 608, 610, and 612 may be sufficient to collect enough information so as to move to block 614 and improve VDI system 100.

FIG. 7 depicts a flow diagram of a method 700 of measuring frames per second (FPS) of VDI screenshots 204, according to an embodiment. Method 700 is a “no reference” method, meaning that local screenshots 206 are not used as a reference in method 700.

At block 702, FPS module 214 sets FPS counter to zero in preparation of starting to count frames in VDI screenshots 204. In an embodiment, a variable N may be set to equal the total number of screenshots in VDI screenshots 204.

At block 704, FPS module 214 chooses a sequential pair of screenshots from VDI screenshots 204. If this is the first time that method 700 reaches block 704, then FPS module chooses the first two screenshots of VDI screenshots 204. If this is not the first time, then FPS module 214 adds the next sequential screenshot to the remaining screenshot of the pair, after the earlier screenshot of the pair was discarded either at block 708, 712, or 716. In an embodiment, choosing a sequential pair of screenshots may be performed by initializing a variable n to 1, and selecting n-th and (n+1)-th sequential screenshots of VDI screenshots 204. When method 700 returns to block 704 from another block (other than block 702), n may be incremented by 1 to choose the next sequential pair.

At block 706, FPS module 214 runs SSIM module 216 to determine whether the pair of screenshots chosen at block 702 are distinct as per the SSIM technique.

At block 708, FPS module 214 determines whether the pair of screenshots chosen at block 702 are distinct as per the SSIM technique. If not, then method 700 discards the earlier screenshot of the pair, and returns to block 704 to choose the next screenshot and create a new pair for processing. If the pair of screenshots chosen at block 702 are distinct as per the SSIM technique, then method 700 continues to block 710.

At block 710, FPS module 214 runs blur CNN 208 to determine if the first screenshot of the pair is blurry.

At block 712. FPS module 214 determines if the first screenshot of the pair is blurry, as per results of blur CNN 208. If so, it is still unclear if the first screenshot is a blurry version of the second, so method 700 continues to block 714. If the first screenshot of the pair is not blurry, then the two screenshots are distinct and method 700 continues to block 718.

At block 714, FPS module 214 feeds both screenshots of the pair into dual blur CNN 210 and runs dual blur CNN 210.

At block 716, FPS module 214 determines if the blurry first screenshot (early in time) is a blurry version of the second screenshot (later in time). If so, then the two screenshots are not distinct, and FPS module 214 discards the first screenshot, and returns to block 704 to choose the next screenshot and create a new pair for processing. If FPS module 214 determines that the blurry first screenshot is not a blurry version of the second screenshot, then the pair of screenshots chosen at block 702 are distinct as per the SSIM technique, then method 700 continues to block 718.

At block 718, FPS module 214 increments FPS counter and continues to block 720.

At block 720, FPS module 214 determines if any more screenshots of VDI screenshots 204 remain for processing, such as by comparing the value of n or n+1 to N. If not, then method 700 ends. If so, then method 700 returns to block 704 to choose the next screenshot for a new screenshot pair for processing.

Below is exemplary pseudocode of an embodiment of method 700.

```
frameCount = 0
For each pair of screenshots Iₙ and Iₙ₊₁ in the sequence of VDI screenshots
204
  If SSIM (Iₙ, Iₙ₊₁ ) < 0.99
  Feed the first screenshot Iₙ into blur CNN 208 to test if it is blurred.
    If In is blurred
      Feed Iₙ and Iₙ₊₁ into dual blur CNN 210
        If Iₙ is NOT blurred version of Iₙ₊₁
          frameCount ++
        EndIf
    Else
      frameCount++
    EndIf
  EndIf
EndFor
FPS = frameCount / Time over which VDI screenshots 204 were recorded
```

FIG. 8 depicts a flow diagram of a method 800 of measuring smoothness of VDI screenshots 204, according to an embodiment.

At block 802, smoothness module 218 obtains an SSIM timeseries of VDI screenshots 204 by computing an SSIM value for pairs of screenshots in VDI screenshots 204. The pairs may be taken by moving down a list of VDI screenshots 204 one screenshot at a time.

At block 804, Fourier transform module 220 computes a Fourier transform graph of the timeseries from block 802.

At block 806, smoothness module 218 computes the energy of the lower ⅔ of the Fourier transform graph (i.e., spectrum) from block 804.

At block 808, smoothness module 218 obtains an SSIM timeseries of local screenshots 206 by computing an SSIM value for pairs of screenshots in VDI screenshots 206. The pairs may be taken by moving down VDI screenshots 206 one screenshot at a time.

At block 810, Fourier transform module 220 computes a Fourier transform graph of the timeseries from block 808.

At block 812, smoothness module 218 computes the energy of the lower ⅔ of the Fourier transform graph (i.e., spectrum) from block 810.

At block 814, smoothness module 218 compares the energy computed at block 806 to energy computed at block 812. If the difference in energies is large enough, then the smoothness metric of VDI system 100 might be considered low (poor visual experience). If the different in energies is small or zero, then smoothness metric of VDI system might be considered high (good visual experience). After block 814, method 800 ends.

FIG. 9 depicts a flow diagram of a method 900 of measuring image quality of VDI screenshots 204, according to an embodiment. In an embodiment, method 900 is a “no reference” method, meaning that local screenshots 206 are not used as a reference while analyzing blurriness and blemishes of VDI screenshots 204.

At block 902, image quality module 224 uses blemish CNN 212 to determine the ratio of unblemished screenshots to total screenshots within VDI screenshots 204.

At block 904, image quality module 224 uses blur CNN 208 to determine the ratio of unblurred screenshots to total screenshots within VDI screenshots 204.

At block 906, image quality module 224 combines the ratios obtained at blocks 902 and 904 to determine the final image quality metric. In an embodiment, image quality module 224 combines the ratios obtained at blocks 902 and 904 using an arithmetic or geometric mean. In an embodiment, only block 902 or 904 is executed in order to measure image quality of VDI screenshots 204, and block 906 uses only a single ratio to determine final image quality. After block 906, method 900 ends.

Below is exemplary pseudocode of an embodiment of method 900.

```
N = Number of screenshots in VDI screenshots 204
B₀ = B₁ = 0
For each screenshot Iₙ in VDI screenshots 204
  If dual blur CNN 210 says Iₙ is NOT blurred
    B₀ += 1
  If blemish CNN 212 says Iₙ has NO blemish
    B₁ +=1
EndFor
Image Quality = geometric mean (B₀/N, B₁/N)
```

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of verifying a quality of virtual desktop infrastructure (VDI) display, the method comprising:
(a) selecting n-th and (n+1)-th sequential screenshots of a set of N screenshots taken on a client device of a VDI system;
(b) performing structural similarity index measure (SSIM) on the two sequential screenshots to determine whether the two sequential screenshots are distinct;
(c) determining whether the n-th screenshot is a blurry version of the (n+1)-th screenshot;
(d) in response to determining that the n-th screenshot is not a blurry version of the (n+1)-th screenshot, incrementing a frames per second (FPS) counter;
(e) incrementing n and repeating steps (a)-(e) until all of the screenshots have been selected; and
(f) verifying the quality of the VDI based on a value of the FPS counter.

2. The method of claim 1, further comprising calculating a smoothness metric, wherein the calculating a smoothness metric comprises:
calculating a pairwise SSIM timeseries of the set of screenshots;
calculating a Fourier transform spectrum of the timeseries;
calculating an energy of the spectrum; and
comparing the energy of the spectrum to an energy derived from a set of screenshots taken locally on a machine.

3. The method of claim 2, wherein the energy of the spectrum is calculated from a lower portion of the spectrum.

4. The method of claim 1, the method further comprising:
creating an arbitrary workload; and
running the arbitrary workload on the VDI system to create the set of screenshots taken on the client device.

5. The method of claim 4, wherein the arbitrary workload executes on a virtual computing instance of a host located in a datacenter of the VDI system.

6. The method of claim 1, the method further comprising:
after the performing SSIM, and prior to determining whether the n-th screenshot is a blurry version of the (n+1)-th screenshot, feeding the n-th screenshot through a first neural net to determine whether the n-th screenshot is blurry.

7. The method of claim 6, wherein the first neural net is a convolutional neural net comprising one or more convolution layers, one or more max pool layers, and one or more fully connected layers.

8. The method of claim 6, further comprising measuring image quality, wherein the measuring of image quality comprises:
determining the presence of blemishes in the set of screenshots taken on the client device, wherein the determining comprises feeding the set of screenshots taken on the client device through a third neural net; and
determining the presence of blurriness in the set of screenshots taken on the client device, wherein the determining comprises feeding the set of screenshots taken on the client device through the first neural net.

9. The method of claim 1, wherein the determining whether the n-th screenshot is a blurry version of the (n+1)-th screenshot comprises feeding the n-th screenshot and the (n+1)-th screenshot through a second neural net.

10. The method of claim 9, wherein the second neural net is a convolutional neural net comprising a top model and a bottom model identical to the top model, wherein each model comprises one or more convolution layers, one or more max pool layers, and one or more fully connected layers.

11. A non-transitory computer readable medium comprising instructions to be executed in a processor of a computer system, the instructions when executed in the processor cause the computer system to carry out a method of verifying a quality of virtual desktop infrastructure (VDI) display, the method comprising:
(a) selecting n-th and (n+1)-th sequential screenshots of a set of N screenshots taken on a client device of a VDI system;
(b) performing structural similarity index measure (SSIM) on the two sequential screenshots to determine whether the two sequential screenshots are distinct;
(c) determining whether the n-th screenshot is a blurry version of the (n+1)-th screenshot;
(d) in response to determining that the n-th screenshot is not a blurry version of the (n+1)-th screenshot, incrementing a frames per second (FPS) counter;
(e) incrementing n and repeating steps (a)-(e) until all of the screenshots have been selected; and
(f) verifying the quality of the VDI based on a value of the FPS counter.

12. The non-transitory computer readable medium of claim 11, further comprising calculating a smoothness metric, wherein the calculating a smoothness metric comprises:
calculating a pairwise SSIM timeseries of the set of screenshots;
calculating a Fourier transform spectrum of the timeseries;
calculating an energy of the spectrum; and
comparing the energy of the spectrum to an energy derived from a set of screenshots taken locally on a machine.

13. The non-transitory computer readable medium of claim 12, wherein the energy of the spectrum is calculated from a lower portion of the spectrum.

14. The non-transitory computer readable medium of claim 11, the method further comprising:
creating an arbitrary workload; and
running the arbitrary workload on the VDI system to create the set of screenshots taken on the client device.

15. The non-transitory computer readable medium of claim 14, wherein the arbitrary workload executes on a virtual computing instance of a host located in a datacenter of the VDI system.

16. The non-transitory computer readable medium of claim 11, the method further comprising:
after the performing SSIM, and prior to determining whether the n-th screenshot is a blurry version of the (n+1)-th screenshot, feeding the n-th screenshot through a first neural net to determine whether the n-th screenshot is blurry.

17. The non-transitory computer readable medium of claim 16, further comprising measuring image quality, wherein the measuring of image quality comprises:
determining the presence of blemishes in the set of screenshots taken on the client device, wherein the determining comprises feeding the set of screenshots taken on the client device through a third neural net; and
determining the presence of blurriness in the set of screenshots taken on the client device, wherein the determining comprises feeding the set of screenshots taken on the client device through the first neural net.

18. The non-transitory computer readable medium of claim 11, wherein the determining whether the n-th screenshot is a blurry version of the (n+1)-th screenshot comprises feeding the n-th screenshot and the (n+1)-th screenshot through a second neural net.

19. The non-transitory computer readable medium of claim 17, wherein the second neural net is a convolutional neural net comprising a top model and a bottom model identical to the top model, wherein each model comprises one or more convolution layers, one or more max pool layers, and one or more fully connected layers.

20. A computer system comprising:
a first processor programmed to perform a method of verifying a quality of virtual desktop infrastructure (VDI) display, the method comprising:
(a) selecting n-th and (n+1)-th sequential screenshots of a set of N screenshots taken on a client device of a VDI system;
(b) performing structural similarity index measure (SSIM) on the two sequential screenshots to determine whether the two sequential screenshots are distinct;
(c) determining whether the n-th screenshot is a blurry version of the (n+1)-th screenshot;
(d) in response to determining that the n-th screenshot is not a blurry version of the (n+1)-th screenshot, incrementing a frames per second (FPS) counter;
(e) incrementing n and repeating steps (a)-(e) until all of the screenshots have been selected; and
(f) verifying the quality of the VDI based on a value of the FPS counter.
